(19) United States
(12) Patent Application Publication
(10) Pub. No.: US 2024/0149242 A1
(43) Pub. Date: May 9, 2024

(54) POLYMER COMPOSITE ARTICLE HAVING RETAINED SOLIDS AND METHODS OF FORMATION

(71) Applicant: W. L. Gore & Associates, Inc., Newark, DE (US)

(72) Inventors: Edward H. Cully, Newark, DE (US); Christine M. Scotti, Newark, DE (US)

(21) Appl. No.: 18/280,422

(22) PCT Filed: Mar. 7, 2022
(86) PCT No.: PCT/US22/19106

§ 371 Date: Sep. 5, 2023

Related U.S. Application Data
(60) Provisional application No. 63/157,442, filed on Mar. 5, 2021.
(60) Provisional application No. 63/302,857, filed on Jan. 25, 2022.

(51) Int. Cl. B01J 20/20; B01D 53/02; B01D 67/00; B01D 69/02; B01D 69/12; B01D 69/14; B01D 71/36; B01J 20/06; B01J 20/26; B01J 20/28; B01J 20/30; B01J 20/32

(52) U.S. Cl. CPC B01J 20/20; B01D 53/02; B01D 67/00793; B01D 67/0083; B01D 69/02; B01D 69/1213; B01D 69/147; B01D 71/36; B01J 20/06; B01J 20/261; B01J 20/28004; B01J 20/28045; B01J 20/3078; B01J 20/321; B01J 20/3225; B01J 20/3236; B01J 20/324; B01J 20/3295; B01D 2253/202; B01D 2253/25; B01D 2257/504; B01D 2323/283; B01D 2325/12

(57) ABSTRACT

A polymer composite article having retained solids is disclosed. The polymer composite article includes a composite region having a first porous polymer comprising a plurality of pores and the retained solids. The composite region has at least a portion of the retained solids immobilized within some of the pores. In embodiments where the retained solids are solid sorbent materials, the article is configured to receive carbon dioxide through the first porous polymer that can be adsorbed onto the solid sorbent.

### CROSS-REFERENCE TO RELATED APPLICATIONS

This application is a national phase application of PCT Application No. PCT/US2022/019106, internationally filed on Mar. 7, 2022, which claims priority to U.S. Provisional Application No. 63/157,442, filed on Mar. 5, 2021, and U.S. Provisional Application No. 63/302,857, filed on Jan. 25, 2022, the disclosure of each application being hereby incorporated herein by reference in its entirety.

### FIELD

The present disclosure to relates a polymer composite article having retained solids, methods of forming the polymer composite article via entrainment, and methods of using the polymer composite article. In embodiments where the retained solids are solid sorbent materials, the article may be used for the purpose of adsorption, including adsorption for direct air capture (DAC) of carbon dioxide.

### BACKGROUND

Increasing carbon dioxide (CO₂) levels associated with greenhouse gas emissions are shown to be harmful to the environment. As reported by the Climate.gov article “Climate Change: Atmospheric Carbon Dioxide,” the 2019 average carbon dioxide level in the atmosphere was 409.8 ppm, the highest level that has been noted in the past 800,000 years. The rate of increase of CO₂ in the atmosphere is also much higher than the rates in previous decades.

In order to limit the impact of climate change, it is not only necessary to reduce CO₂ emissions in the near future to zero but also to achieve negative CO₂ emissions. Several possibilities exist in order to achieve negative emissions, e.g. combustion of biomaterials for the generation of electricity combined with CO₂ capture from the combustion flue gas and subsequent CO₂ sequestration (“BECCS”) or direct air capture of CO₂ (“DAC”).

Gas separation by adsorption has many different applications in industry, for example removing a specific component from a gas stream, where the desired product can either be the component removed from the stream, the remaining depleted stream, or both. Thereby, both trace components as well as major components of the gas stream can be targeted by the adsorption process. One important gas separation application is in capturing CO₂ from gas streams, e.g., from flue gases, exhaust gases, industrial waste gases, biogas or atmospheric air. Atmospheric air is considered a dilute feed stream of CO₂.

Capturing CO₂ directly from the atmosphere, referred to as DAC, is one of several means of mitigating anthropogenic greenhouse gas emissions and has attractive economic prospects as a non-fossil, location-independent CO₂ source for the commodity market and for the production of synthetic fuels. The specific advantages of CO₂ capture from the atmosphere include: a) DAC can address the emissions of distributed sources (e.g. vehicles . . . land, sea and air), which account for a large portion of the worldwide greenhouse gas emissions and can currently not be captured at the site of emission in an economically feasible way; b) DAC can address legacy emissions and can therefore create truly negative emissions, and c) DAC systems do not need to be attached to the source of emission but may be location independent and can be located at the site of further CO₂ processing or usage.

There is increasing motivation to develop and improve upon these processes to make them more efficient, maximizing the amount of CO₂ removed from the atmosphere while minimizing the energy required in the process.

FIG. 1 is a schematic diagram of the process involved in a traditional DAC system 10. An input feed stream 11 is provided, containing a mixture of CO₂ molecules 16 in a non-CO₂ diluent 18. For example, the input feed stream 11 may be an air stream. During an adsorption process, the input feed stream 11 is exposed to an adsorbent 12. The CO₂ molecules 16 adsorb onto the adsorbent 12, while the non-CO₂ diluent 18 passes the adsorbent 12 and is exhausted from the system 10. The adsorbent 12 then undergoes a process of desorption in order to release the CO₂ molecules 16 from the adsorbent 12. The desorption process may involve moisture in the form of liquid water or steam or changes in the system temperature through reactions or energy delivered to the system. This desorption process is referred to as a “swing” adsorption to define the cyclic process of repeatedly adsorbing and desorbing of CO₂. If moisture swing adsorption is being used, the adsorbent 12 may be exposed to moisture in the form of water vapor or liquid water to cause the desorption of the CO₂ molecules 16. If temperature swing adsorption is being used, heat may be applied to the adsorbent 12 to cause desorption of the CO₂ molecules 16. These moisture and/or temperature swings temporarily break the bonds that retain the molecules to the adsorbent 12 so that the CO₂ molecules16 can be released. The desorbed CO₂ molecules 16 are thus separated from the adsorbent 12 and collected as the output 14. The collected CO₂ molecules 16 can then be concentrated and subjected to further necessary processes before being used or stored. It is important that the adsorbent 12 used is able to repeatedly withstand the environments necessary for separating the CO₂ molecules 16, such as high temperatures and high moisture conditions.

There are established articles and techniques for DAC. An example is using an article including a substrate such as a monolith that supports or is coated with a sorbent material. Variations are established by changing the type of substrate and the sorbent that is used. However, these previously established articles and methods present limitations in the ability to efficiently cycle between adsorbing and desorbing states. They also have limitations with respect to the durability of the article. The articles may also degrade when exposed to high temperatures or high moisture level environments, or combinations thereof, which can result in a shorter lifetime.

### SUMMARY

An entrained polymer composite article is disclosed. The entrained polymer composite article includes a composite region having a porous polymer comprising a plurality of pores and a solid material. The composite region has at least a portion of the solid material that has been entrained, retained and immobilized within some of the pores. When the article is entrained with a solid sorbent material, the article may be configured to receive carbon dioxide through the porous polymer that can be adsorbed onto the solid sorbent.

According to one example (“Example A”), a sorbent polymer composite article includes a first region having a solid sorbent and a first porous polymer, the first porous polymer including a plurality of pores, the first region having at least a portion of the solid sorbent immobilized within at least some of the pores of the first porous polymer, and the first region being configured to receive carbon dioxide through the first porous polymer and adsorb the carbon dioxide onto the solid sorbent.

According to a second example (“Example B”), a method of combining a solid sorbent and a first porous polymer includes the steps of providing a first porous polymer having a plurality of pores, providing a solid sorbent, combining the sorbent and the first porous polymer such that at least a portion of the sorbent is disposed within the pores of the first porous polymer, and immobilizing the solid sorbent within the pores of the first porous polymer.

According to a third example (“Example C”), an entrained polymer composite article includes a first porous polymer including a plurality of nodes, a plurality of fibrils that connect adjacent nodes, and a plurality of pores defined by the nodes and the fibrils. The first porous polymer has a first state in which the fibrils are substantially straight, a second state in which the fibrils are substantially wavy or bent and the pores are smaller in size than in the first state, and a plurality of solid particles being retained in the pores in the first state and immobilized in the pores in the second state.

### BRIEF DESCRIPTION OF THE DRAWINGS

FIG. 1 is a schematic diagram of the process involved in a DAC system.

FIG. 2 is an elevational view of a sorbent polymer composite article of the present disclosure.

FIG. 2A is a schematic elevational view of the first composite region of the first composite article of FIG. 2.

FIG. 2B is a schematic elevational view of the first composite region of a compressed form of the first composite article of FIG. 2.

FIG. 2C is a schematic elevational view of the first composite region of a further compressed form of the first composite article of FIG. 2B.

FIG. 2D is an elevational view of the first sorbent polymer composite article of FIG. 2 illustrated with an end-sealing region of the present disclosure.

FIG. 3 is a flow chart illustrating a method of forming the sorbent polymer composite article of FIG. 2.

FIG. 4A is an elevational view of a first region of the sorbent polymer composite article prior to an immobilization step.

FIG. 4B is an elevational view of the first region of the sorbent polymer composite article of FIG. 4A after an immobilization step.

FIG. 5A is an elevational view of the first region and the second region of a sorbent polymer composite article during a combining step.

FIG. 5B is an elevational view of the sorbent polymer composite article of FIG. 6A during an immobilization step.

FIGS. 6A, 6B, and 6C are SEM images of a polymer composite article sample with retained diamond particles according to Example 1.

FIGS. 7A, 7B, and 7C are SEM images of a polymer composite article sample with retained iron oxide particles according to Example 2.

### DETAILED DESCRIPTION OF THE INVENTION

### Definitions and Terminology

This disclosure is not meant to be read in a restrictive manner. For example, the terminology used in the application should be read broadly in the context of the meaning those in the field would attribute such terminology.

With respect to terminology of inexactitude, the terms “about” and “approximately” may be used, interchangeably, to refer to a measurement that includes the stated measurement and that also includes any measurements that are reasonably close to the stated measurement. Measurements that are reasonably close to the stated measurement deviate from the stated measurement by a reasonably small amount as understood and readily ascertained by individuals having ordinary skill in the relevant arts. Such deviations may be attributable to measurement error, differences in measurement and/or manufacturing equipment calibration, human error in reading and/or setting measurements, minor adjustments made to optimize performance and/or structural parameters in view of differences in measurements associated with other components, particular implementation scenarios, imprecise adjustment and/or manipulation of objects by a person or machine, and/or the like, for example. In the event it is determined that individuals having ordinary skill in the relevant arts would not readily ascertain values for such reasonably small differences, the terms “about” and “approximately” can be understood to mean plus or minus 10% of the stated value.

The term “fibril” as used herein describes an elongated piece of material such as a polymer, where the length and width are substantially different from each other. For example, a fibril may resemble a piece of string or fiber, where the width (or thickness) is much shorter or smaller than the length.

The term “node” as used herein describes a connection point of at least two fibrils, where the connection may be defined as a location where the two fibrils come into contact with each other, permanently or temporarily. In some examples, a node may also be used to describe a larger volume of polymer than a fibril and where a fibril originates or terminates with no clear continuation of the same fibril through the node. In some examples, a node has a greater width but a smaller length than the fibril.

As used herein, “nodes” and “fibrils” may be used to describe objects that are usually, but not necessarily, connected or interconnected, and have a microscopic size, for example. A “microscopic” object may be defined as an object with at least one dimension (width, length, or height) that is substantially small such that the object or the detail of the object is not visible to the naked eye or difficult, if not impossible, to observe without the aid of a microscope, including but not limited to a scanning electron microscope (SEM) for example, or any suitable type of magnification device.

### DESCRIPTION OF VARIOUS EMBODIMENTS

The present disclosure relates to a polymer composite article having retained solids, methods of forming the polymer composite article via entrainment, and methods of using the polymer composite article. In embodiments where the retained solids are solid sorbent materials, the article may be used to adsorb and separate one or more desired substances from a source stream. While the sorbent polymer composite article is described below for use in DAC of carbon dioxide from a dilute feed stream, such as air, it may be used in other adsorbent methods and applications. These methods include, but are not limited to, adsorption of substances from various inputs, including other gas feed streams (e.g., combustion exhaust) and liquid feed streams (e.g., ocean water). The adsorbed substance is not limited to carbon dioxide. Other adsorbed substances may include, but are not limited to, other gas molecules (e.g., N₂, CH₄, and CO), liquid molecules, and solutes. In certain embodiments, the input may be dilute, containing on the order of parts per million (ppm) of the adsorbed substance. The article may retain other solid materials for other uses, including pharmaceutical uses and biological uses.

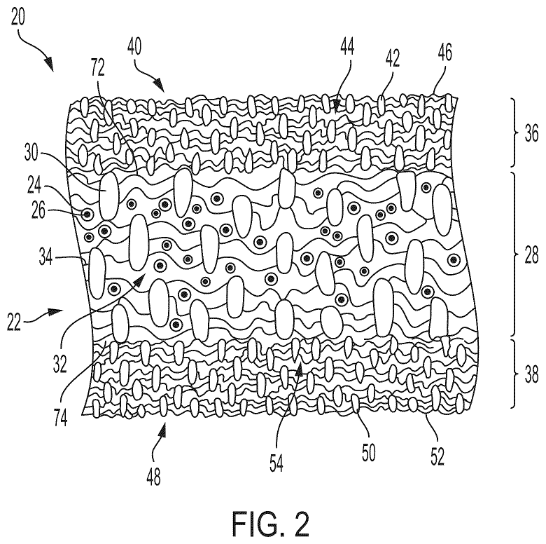

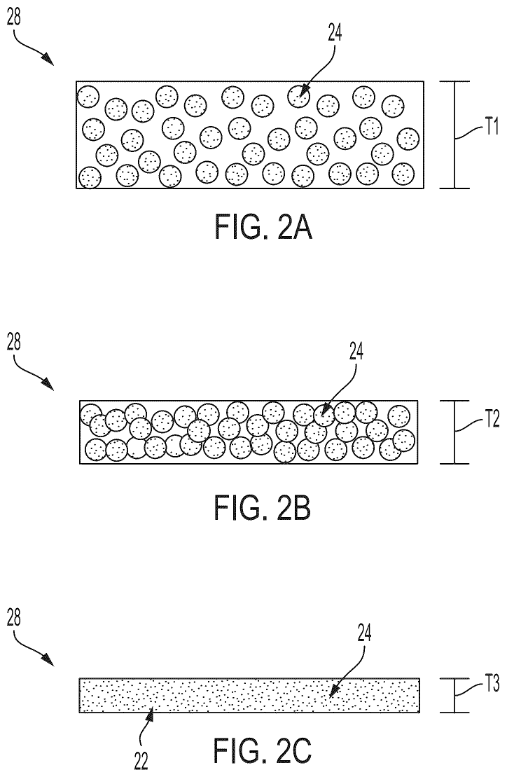

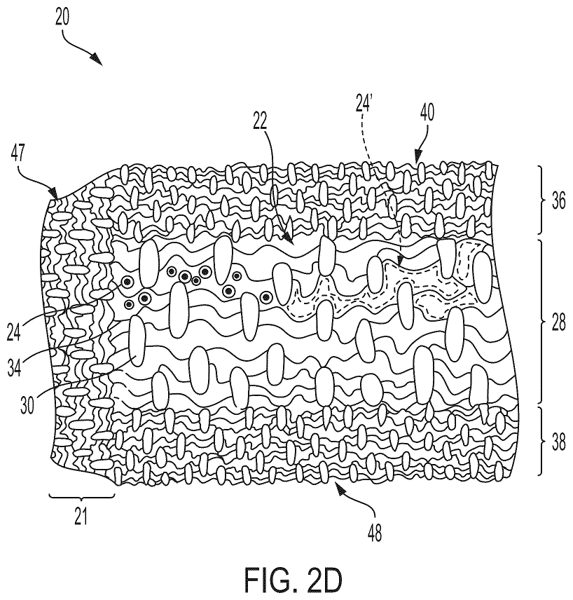

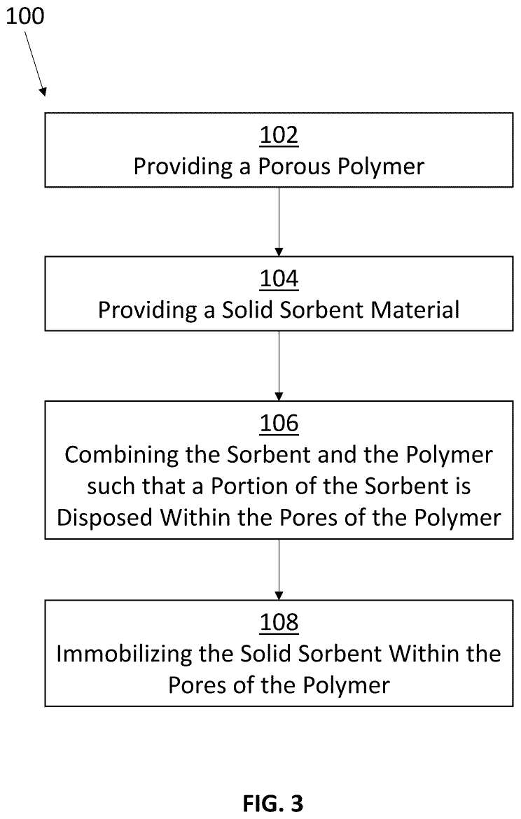

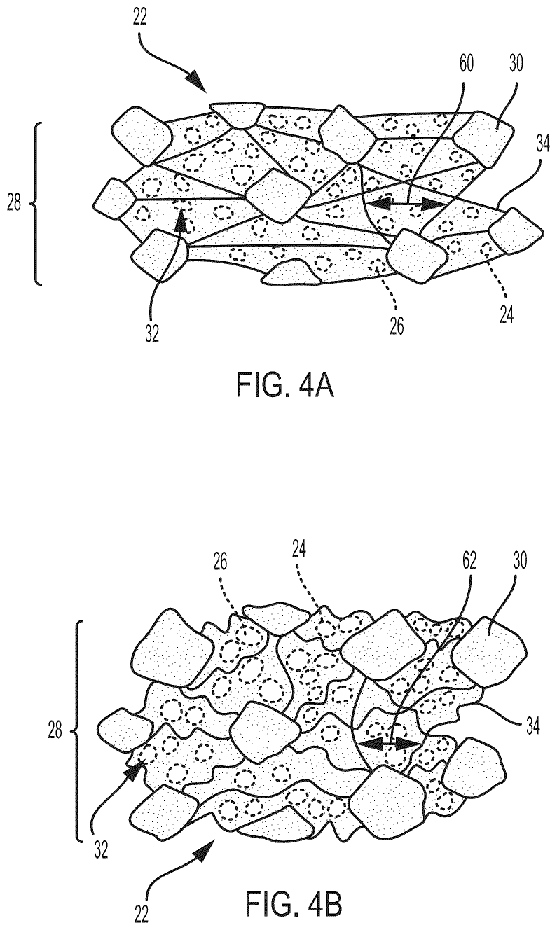

FIG. 2 shows a first exemplary polymer composite article, specifically a sorbent polymer composite article 20, including a first composite region 28. The first composite region 28 includes a first porous polymer 22 and retained solids illustratively comprising a sorbent material 24. The retained solids may also include an optional carrier 26. Each element of the first composite region 28 is described further below.

The first porous polymer 22 of the first composite region 28 may be one of expanded polytetrafluoroethylene (ePTFE), expanded polyethylene (ePE), polytetrafluoroethylene (PTFE), or another suitable porous polymer. It will be appreciated that non-woven materials such as nanospun, meltblown, spunbond and porous cast films may be among the various other suitable porous polymer forms. The first porous polymer 22 may be expanded by stretching the polymer at a controlled temperature and a controlled stretch rate, causing the polymer to fibrillate. Following expansion, the first porous polymer 22 may comprise a microstructure of a plurality of nodes 30 and a plurality of fibrils 34 that connect adjacent nodes 30. In these instances, the first porous polymer 22 includes pores 32 bordered by the fibrils 34 and the nodes 30. An exemplary node and fibril microstructure is described in U.S. Pat. No. 3,953,566 to Gore, incorporated herein by reference in its entirety. The pores 32 of the first porous polymer 22 may be considered micropores. Such micropores may have a single pore size or a distribution of pore sizes. The average pores size may range from 0.1 microns to 100 microns in certain embodiments.

The sorbent material 24 of the first composite region 28 is a substrate having a surface configured to hold the desired substance from the input as a thin film on the surface via adsorption. The sorbent material 24 varies based on which substances are targeted for adsorption. In various embodiments, the sorbent material 24 is a carbon dioxide adsorbing material which may include, but is not limited to, an ion exchange resin (e.g., a strongly basic anion exchange resin such as Dowex™ Marathon™ A resin available from Dow Chemical Company), zeolite, activated carbon, alumina, metal-organic frameworks, polyethyleneimine (PEI), or another suitable carbon dioxide adsorbing material, such as desiccant, carbon molecular sieve, carbon adsorbent, graphite, activated alumina, molecular sieve, aluminophosphate, silicoaluminophosphate, zeolite adsorbent, ion exchanged zeolite, hydrophilic zeolite, hydrophobic zeolite, modified zeolite, natural zeolites, faujasite, clinoptilolite, mordenite, metal-exchanged silico-aluminophosphate, uni-polar resin, bi-polar resin, aromatic cross-linked polystyrenic matrix, brominated aromatic matrix, methacrylic ester copolymer, graphitic adsorbent, carbon fiber, carbon nanotube, nano-materials, metal salt adsorbent, perchlorate, oxalate, alkaline earth metal particle, ETS, CTS, metal oxide, chemisorbent, amine, organo-metallic reactant, hydrotalcite, silicalite, zeolitic imadazolate framework and metal organic framework (MOF) adsorbent compounds, and combinations thereof.

The sorbent material 24, 24′ may be present in the first porous polymer 22 as a coating, a filling, entrained particles, and/or in another suitable form, as described further below. In the illustrated embodiment of FIG. 2, solid particles of the sorbent material 24 on the carrier 26 are entrained in the first porous polymer 22, such that the particles occupy and are retained within the pores 32 between the nodes 30 and fibrils 34 of the first porous polymer 22. It is also within the scope of the present disclosure for the first porous polymer 22 to be coated with the sorbent material 24′, such that the sorbent material 24′ forms a substantially continuous coating on the nodes 30 and/or fibrils 34 of the first porous polymer 22, as shown in FIG. 2D. It is further within the scope of the present disclosure for the first porous polymer 22 to be filled with the sorbent material 24, such that the sorbent material 24 is incorporated into the nodes 30 and/or fibrils 34 of the first porous polymer 22.

The optional carrier 26 of the first composite region 28 is a material that is configured to increase the surface area of the region it occupies which may allow for an increased surface area that is available for adsorption of the desired substance. The carrier 26 may include a mesoporous silica, polystyrene beads, porous polymeric bed or sphere, oxide supports or another suitable carrier material. The carrier 26 may further include a porous film comprising porous inorganic materials within it such as calcium sulfate, alumina, activated charcoal and fumed silica. As noted above, the carrier 26 may be present in the pores 32 of the first composite region 28 as high surface area particles that are coated or functionalized with the sorbent material 24. The combination of the carrier 26 coated with the sorbent material 24 increases the surface area available for adsorption. In these embodiments, the nodes 30 and fibrils 34 may or may not be coated with sorbent material 24. When the nodes 30 and fibrils 34 are not coated, the original hydrophobicity of the first porous polymer 22 may be retained.

The first composite region 28 of the sorbent polymer composite article 20 includes a first side 72 (e.g., an upper side in FIG. 2) and a second side 74 (e.g., a lower side in FIG. 2). The sorbent polymer composite article 20 further includes a second region 36 comprising a second porous polymer 40, where the second region 36 is positioned adjacent the first side 72 of the first composite region 28. In various embodiments, the sorbent polymer composite article also includes a third region 38 comprising a third porous polymer 48, where the third region 38 is positioned adjacent the second side 74 of the first composite region 28. In this way, the first composite region 28 may be sandwiched between the second region 36 on the first side 72 and the third region 38 on the second side 74. The second porous polymer 40 of the second region 36 may comprise a plurality of nodes 42, a plurality of fibrils 46 that connect adjacent nodes 42, and a plurality of pores 44 that are each formed between the respective nodes 42 and fibrils 46. Similarly, the third porous polymer 48 of the third region 38 may comprise a plurality of nodes 50, a plurality of fibrils 52 that connect adjacent nodes 50, and a plurality of pores 54 formed between the respective nodes 50 and fibrils 52. The pores 44 of the second porous polymer 40 and/or the pores 54 of the third porous polymer 48 may be considered micropores, as described further above.

The first composite region 28, the second region 36, and the third region 38 of the sorbent polymer composite article 20 may be formed using different processes. In certain embodiments, the first composite region 28, the second region 36, and/or the third region 38 may be formed as discrete layers and then coupled together. In this case, the first porous polymer 22 of the first composite region 28, the second porous polymer 40 of the second region 36, and/or the third porous polymer 48 of the third region 38 may be distinct structures. In other embodiments, the first composite region 28, the second region 36, and/or the third region 38 may be formed together and then subjected to different coating processes or surface treatments, as described further below, to differentiate certain regions. In this case, the first porous polymer 22 of the first composite region 28, the second porous polymer 40 of the second region 36, and/or the third porous polymer 48 of the third region 38 may be continuous or integrated structures.

The first composite region 28, the second region 36, and the third region 38 of the sorbent polymer composite article 20 may have differing degrees of hydrophobicity. The hydrophobicity may be altered through various methods, such as through applying coatings or surface treatments which can include, but are not limited to, plasma etching and applying micro-topographical features. The first composite region 28 has a first hydrophobicity, the second region 36 may have a second hydrophobicity, and the third region 38 may have a third hydrophobicity. The first hydrophobicity is less than that of each the second hydrophobicity and the third hydrophobicity. The second hydrophobicity may be greater than, less than, or equal to the third hydrophobicity. The greater hydrophobicity of the second region 36 and the third region 38 may reduce the permeation of liquid water through the respective regions 36, 38, thus forming a barrier between any liquid water in the surroundings and the components of the first composite region 28. This reduces degradation of the sorbent material 24, 24′ within the first composite region 28 that liquid water could cause, increasing the lifetime and durability of the sorbent polymer composite article 20. The greater hydrophobicity of the second region 36 and the greater hydrophobicity of the third region 38 relative to the first hydrophobicity of the first composite region 28 may result from the lack of sorbent material 24, 24′ within the second and third regions 36, 38.

In some embodiments, the first composite region 28 is sealed with a coating (not shown). In certain instances, the coating is configured to be a carbon adsorbing material similar to the above-described sorbent material 24.

The second porous polymer 40 of the second region 36 and the third porous polymer 48 of the third region 38 may be at least one of polytetrafluoroethylene (PTFE), expanded polytetrafluoroethylene (ePTFE), expanded polyethylene (ePE), or other suitable porous polymers. The second porous polymer 40 of the second region 36 may be identical to or different from the third porous polymer 48 of the third region 38. Further, the first porous polymer 22 of the first composite region 28, the second porous polymer 40 of the second region 36, and the third porous polymer 48 of the third region 38 may be identical to or different from each other.

In various embodiments, the thickness of the second region 36 is less than that of the first composite region 28, and the thickness of the third region 38 is less than that of the first composite region 28. The overall thickness of the sorbent polymer composite article 20 may be about 0.1 mm to about 5.0 mm. In certain embodiments, the thickness of the first composite region 28 may account for a majority of the overall thickness, such as about 70%, about 80%, about 90%, or more of the overall thickness.

The pore characteristics of the porous polymers 22, 40, 48 of each of the respective first composite region 28, the second region 36, and the third region 38 are variable. In certain embodiments, the second and third regions 36, 38 may have fewer and/or smaller pores 44, 54, than the first composite region 28 to selectively limit permeation of undesired fluids (e.g., water) into the first composite region 28 while permitting permeation of desired molecules (e.g., CO₂) into the first composite region 28. By contrast, the first composite region 28 may have more and/or larger pores 32 than the second and third regions 36, 38 to encourage movement of CO₂ through the first composite region 28 for adsorption and desorption.

Further, the pore characteristics can be varied among different embodiments. This variation of the pore characteristics can be dependent on the entire thickness of the sorbent polymer composite article 20, as well as of the individual thicknesses of the first composite region 28, second region 36 and third region 38.

FIG. 2A is a schematic elevational view of the first composite region 28 of the sorbent composite article 20 of FIG. 2. In this embodiment, the sorbent polymer composite article 20 (FIG. 2) is relatively thick, for example approximately 3 mm, and the first composite region 28 has a thickness T1 that accounts for a majority of the overall thickness of the sorbent polymer composite 20. The sorbent polymer composite article 20 may be loaded with a desired amount of sorbent material 24 (e.g., about 60% sorbent material 24) to retain a relatively large void fraction, wherein the void fraction is a relative ratio of a volume of void space of the first composite region 28 to an entire volume of the first composite region 28. In this way, the sorbent polymer composite article 20 is relatively open in structure and there is relatively high accessibility of the sorbent material 24 While the distance required for diffusion of the gases may be farther in this embodiment due to the thickness T1, the sorbent material 24 remains accessible to the gases. As a result, the initial kinetics of the gas adsorbing to the sorbent material 24 may be slow, but the equilibrium of CO₂ adsorbing to the sorbent material 24 can be reached quickly in comparison to embodiments that are thinner, as will be described herein.

FIG. 2B is an alternate embodiment of the first composite region 28 of FIG. 2A wherein the sorbent composite article 20 (FIG. 2) has a median thickness, for example approximately 0.5 mm. In this embodiment, the first composite region 28 has a thickness T2 that accounts for the majority of the overall thickness of the sorbent polymer composite article 20. In this case, if the amount of polymer 22 (FIG. 2) of the first composite region 28 and the amount of sorbent material 24 is constant relative to the previous embodiment, the void fraction will be relatively smaller than the void fraction of the first composite region 28 of FIG. 2A. Thus, the sorbent polymer composite article 20 maintains a porosity wherein the gas is accessible to the sorbent material 24 but comparatively less accessible than the sorbent material 24 of the FIG. 2A embodiment. As a result, the initial kinetics of the gas adsorbing to the sorbent material 24 may be faster due to the shorter diffusion distance, but the time for equilibrium of CO₂ adsorption will increase relative to that of the embodiment in FIG. 2A.

FIG. 2C is alternate embodiment of the first composite region 28 of FIGS. 2A and 2B, wherein the sorbent polymer composite article 20 (FIG. 2) is relatively thin, for example approximately 0.1 mm. In this embodiment, the first composite region 28 has a thickness T3 that accounts for the majority of the overall thickness of the sorbent polymer composite article 20. In this case, if the amount of polymer 22 (FIG. 2) of the first composite region 28 and the amount of sorbent material 24 is constant relative to the previous two embodiments, the polymer 22 and available sorbent material 24 will be condensed even further within the sorbent polymer composite article 20. The diffusion distance required for the gases to pass through the article 20 is shorter due to the compressed thickness of the sorbent polymer composite article 20, but the sorbent material 24 is also less accessible to the gases. As a result, the initial kinetics of adsorption of the gases to the sorbent material 24 will be faster than the previous embodiments, but it may take longer for the system to reach a CO₂ adsorption equilibrium.

Referring back to FIG. 2, the pore characteristics of the sorbent polymer composite 20 may be varied within each layer, but also across various embodiments as a result of changing various characteristics, including the thickness of the sorbent polymer composite article 20, the thickness of the first composite region 28, the amount of sorbent material 24, and the amount of polymer 22 used within the sorbent polymer composite article 20. In this way, the relationship between diffusion length and sorbent material 24 accessibility can be varied for maximizing the function of the sorbent polymer composite article 20.

The ability to vary the hydrophobicity, thickness, porosity, and other properties of the first composite region 28, the second region 36, and the third region 38 may increase durability and conformability of the sorbent polymer composite article 20. For example, the increased porosity of the second region 36 and third region 38 may decrease permeation of fluids into the first region, while allowing for desired molecules, such as carbon dioxide, to permeate. Further, the use of a relatively thin and flexible sorbent polymer composite article 20 may allow the sorbent polymer composite article 20 to conform to different configurations for adsorption and desorption of the carbon dioxide.

In certain instances, a tensile strength of the sorbent polymer composite article 20 as a whole (the first porous polymer 22 with the sorbent material 24) is equal or substantially equal to a strength of the first porous polymer 22 alone (without the sorbent material 24). In conventional filling processes, the first porous polymer 22 may lose strength based on how much filler (in this case, sorbent material 24) has been incorporated into the microstructure of the first porous polymer 22. In the present disclosure, by contrast, the first porous polymer 22 is expanded before introducing the sorbent material 24, which allows the first porous polymer 22 to be fully formed without weakening the microstructure of the first porous polymer 22. The amount of sorbent material 24 added after expansion can be increased or decreased with little to no effect on the strength of the first porous polymer 22. Thus, the first porous polymer 22 may have a tensile strength after entrainment of a sorbent material 24 that is approximately equal to an original tensile strength of the first porous polymer 22 prior to the addition of the sorbent material 24. In this way, the presence of the sorbent material 24 with the first porous polymer 22 in the sorbent polymer composite article 20 may not degrade the strength of the first porous polymer 22. As a result, the strength of the first porous polymer 22 can be controlled which then controls the strength of the sorbent polymer composite article 20 as a whole, regardless of how much sorbent material 24 is entrained into the sorbent polymer composite article 20. The tensile strength may be measured by stretching the first porous polymer 22 and/or the sorbent polymer composite article 20 and measuring deformation at different force values, as known in the art.

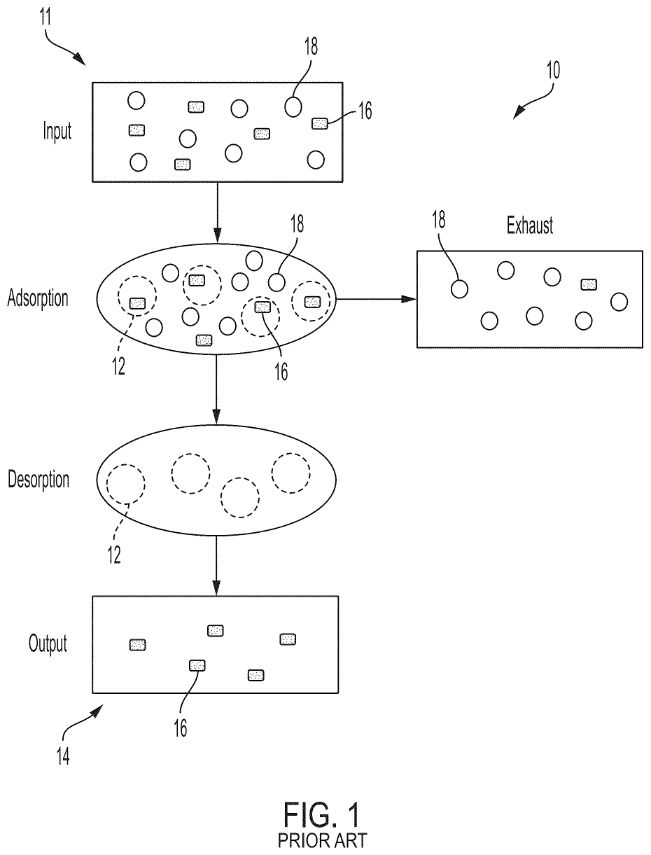

The sorbent polymer composite article 20 of FIG. 2 may be used for various adsorption methods. During an adsorption stage, an input feed stream (similar to feed stream 11 of FIG. 1) may be directed across the sorbent polymer composite article 20 to adsorb CO₂ molecules. Then, during a desorption stage, the sorbent polymer composite article 20 may be subjected to a moisture swing and/or temperature swing process to desorb the CO₂ molecules. As noted above, the polymer composite article 20 may also have other uses beyond adsorption, where it is desired to entrain the first porous polymer 22 with solid particles more generally. This may include pharmaceutical uses such as for entraining a porous polymer with a therapeutic agent, or in biological uses such as for entraining a porous polymer with cells.

FIG. 2D is an additional elevational view of the sorbent polymer composite article of FIG. 2 with an additional end-sealing region 21. In embodiments, the sorbent polymer composite article 20 includes this end-sealing region 21 to protect the components of the sorbent polymer composite article 20. For example, if the sorbent polymer composite article 20 is cut or split in any manner, such as for production or manufacturing purposes, it may leave the first composite region 28, and thus the sorbent material 24, 24′ within the first composite region 28, exposed to external environment elements such as water or steam, which may be harmful to properties of the sorbent polymer composite article 20. Thus, embodiments with an end-sealing region 21 may be desirable. As illustrated in FIG. 2D, the end-sealing region 21 is positioned such that it may connect the polymer 40 of the second region 36 and the polymer 48 of the third region 38 and covers the exposed polymer of the first composite region 28 on at least one side.

In the illustrated embodiment of FIG. 2D, the end-sealing region 21 is formed by applying an additional layer of a sealing material 47 onto the sorbent polymer composite article 20. The sealing material 47 may be the same as or different from the materials of the second region 36 and the third region 38. For example, the sealing material 47 may be ePTFE (as shown in FIG. 2A), ePE, silicone elastomer, or any other suitable non-porous and/or hydrophobic material that protects the first composite region 28. In other embodiments, the end-sealing region 21 may be formed by extending the second region 36 and the third region 38 and coupling (e.g., pinching, adhering) the regions 36, 38 together. The addition of this edge sealing step will benefit the composite by protecting the sorbent(s) retained in the composite and also by toughening the leading edge of the composite (which is the area most likely to incur damage from airborne debris and high-velocity strikes).

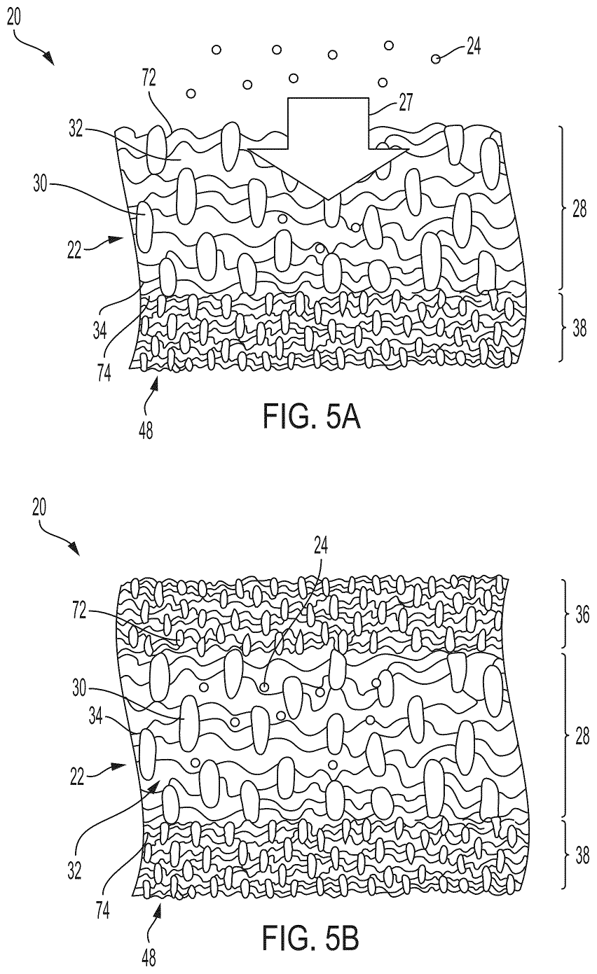

FIG. 3 is a flow chart illustrating a method 100 for forming the first composite region 28 of the sorbent polymer composite article 20 of FIG. 2. At block 102, the method 100 first includes providing the first porous polymer 22. The first porous polymer 22 may be ePTFE, PTFE, or ePE, as noted above, or any other suitable porous polymer.

At block 104, the method 100 includes providing the solid sorbent material 24 in particle (e.g., powder) form, including the optional carrier 26. The particles of the solid sorbent material 24 may have an average particle size of about 0.1 μm to about 100 μm, more specifically about 1 μm to about 10 μm.

At block 106, the method 100 next includes combining the particles of the solid sorbent material 24 and the first porous polymer 22 with a portion of the particles of the sorbent material 24 being disposed within the pores 32 of the first porous polymer 22. In wet entraining embodiments, the combining step includes delivering a slurry (not shown) comprised of the particles of the sorbent material 24 and a liquid carrier (e.g., water) to the first porous polymer 22. The first porous polymer 22 may be dipped into and saturated with the slurry, and then the liquid carrier may be removed to leave behind the retained particles of the sorbent material 24 in the pores 32. This wet entraining process may be similar to a liquid filtration process, with the retained sorbent material 24 of the wet entraining process being similar to the retentate of the filtration process. In dry entraining embodiments, the combining step includes applying the particles of the solid sorbent material 24 in a dry particle form to the first porous polymer 22 using a forced air flow (e.g., positive pressure or negative pressure or a combination thereof). After the combining step of block 106, pores 32 of the first porous polymer 22 may retain particles of the sorbent material 24. As a result, the pores 32 of the first porous polymer 22 may be packed with the particles of the sorbent material 24. The amount of packing may be altered based on pore size, particle size and pressures involved in the process and time in the process. Advantageously, both the wet and dry entraining processes of block 106 may preserve the physical and chemical structure of the particles of the sorbent material 24. Thus, as noted above, the wet and dry entraining processes of block 106 may be suitable for use with a variety of solid particles beyond the solid particles of sorbent material 24 described herein, including drugs, therapeutic agents, and living cells.

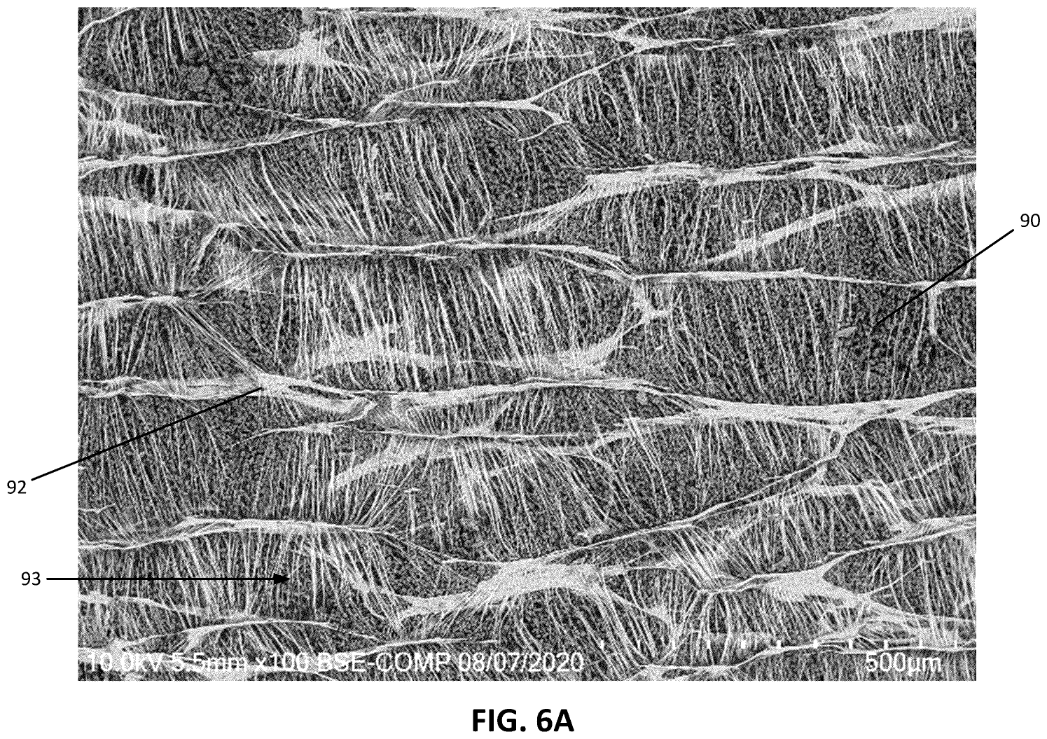

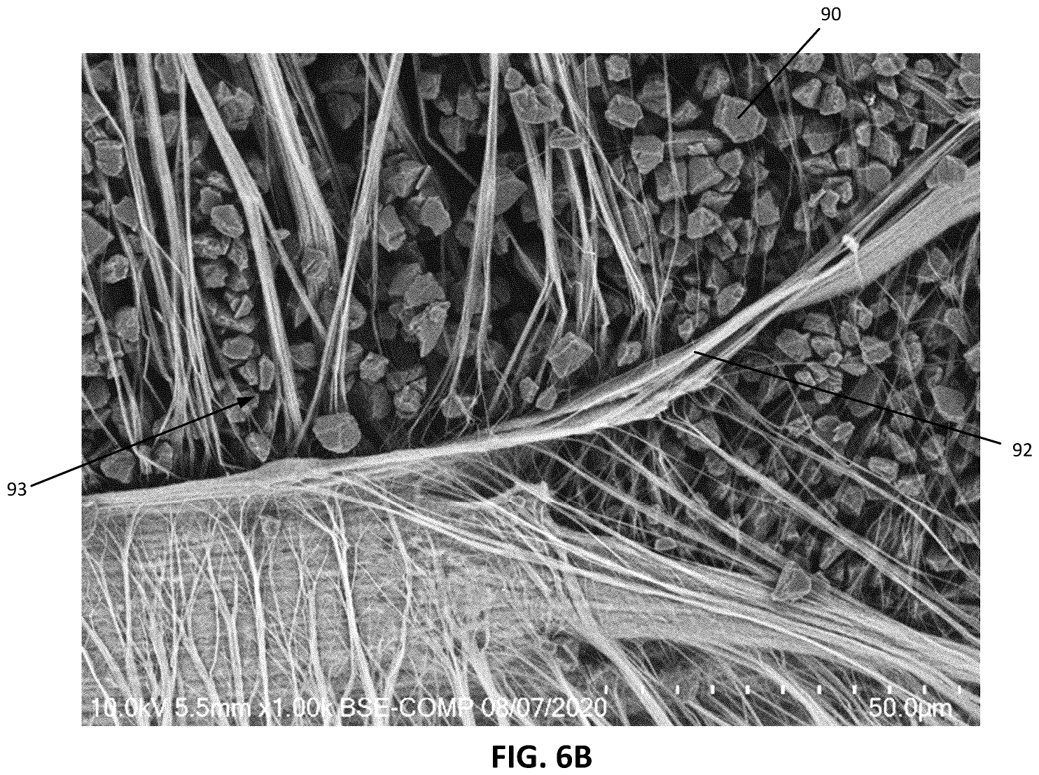

At block 108, the method 100 further includes immobilizing the particles of the sorbent material 24 within the pores 32 of the expanded first porous polymer 22 of the first composite region 28. In solvent shrinking embodiments, this immobilizing step may include applying a suitable solvent (e.g., isopropyl alcohol (IPA)) to the combination of the first porous polymer 22 and the sorbent material 24 to flood the first porous polymer 22 and subsequently evaporating the solvent. This application of the solvent and subsequent evaporation of the solvent is configured to shrink the fibrils 34, thereby tightening the pores 32 of the first porous polymer 22 of the first composite region 28 and capturing the particles of the solid sorbent material 24 within the pores 32, as shown and described below with respect to FIGS. 4A and 4B. In heat shrinking embodiments, the immobilizing step may include applying heat to the combination of the solid sorbent material 24 and the first porous polymer 22. The application of heat may shrink the fibrils 34, thereby tightening the pores 32 of the first porous polymer 22 and capturing the particles of the solid sorbent material 24 within the pores 32. This heating step should be performed at a temperature high enough to evaporate the solvent and shrink the fibrils 34 but low enough to avoid damaging the sorbent material 24, such as about 60° C. to about 200° C. It is also within the scope of the present disclosure to perform both solvent shrinking and heat shrinking processes. The immobilizing step may cause the porosity of the first porous polymer 22 to decrease. After the immobilizing step of block 108, the pores 32 of the first porous polymer 22 may be tightly packed (e.g., plugged) with the particles of the sorbent material 24.

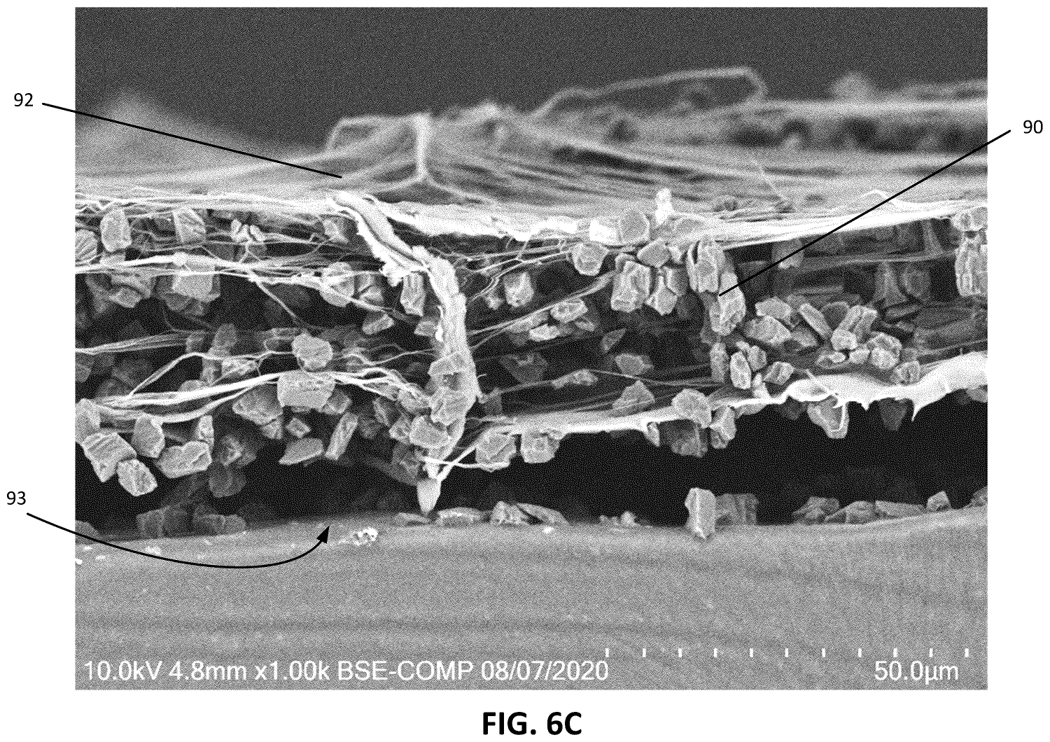

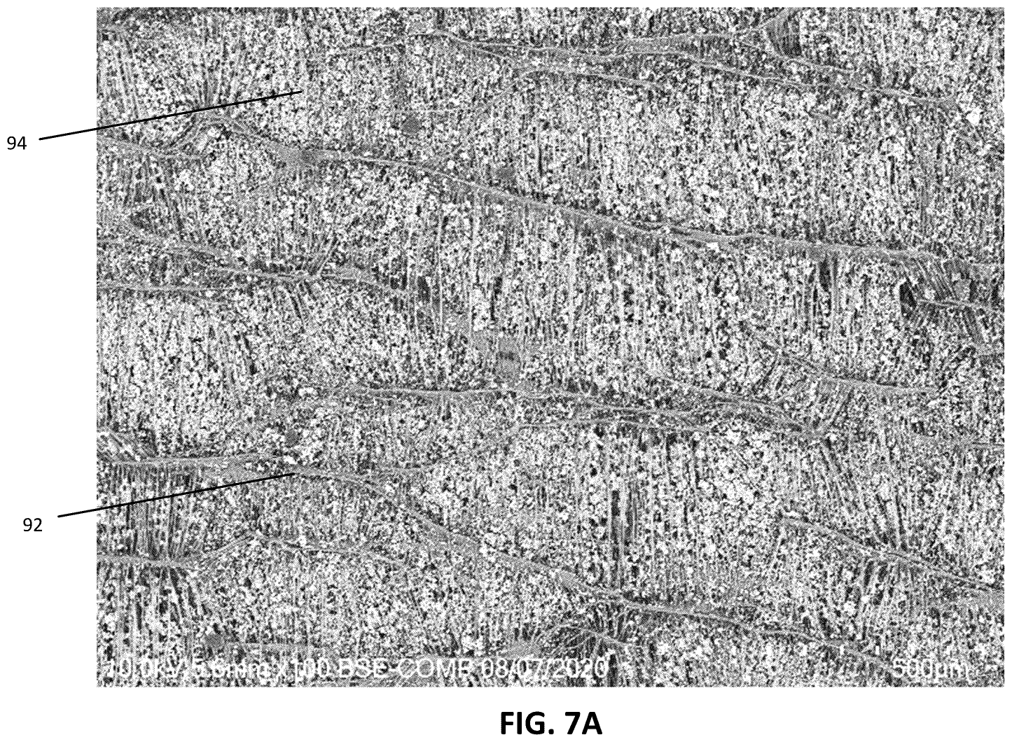

Further, in various embodiments, the immobilizing step may comprise attaching one or more coating regions, such as the second region 36 including the second porous polymer 40 and/or the third coating region 38 including the third porous polymer 48 (FIG. 2), onto the first porous polymer 22 such that the particles of the solid sorbent material 24 are trapped within the pores 32 of the first porous polymer 22. In certain instances, the porous polymers 40, 48 are PTFE, ePTFE, ePE, or other suitable porous polymers as noted above. In various embodiments, this attaching of the second region 36 and/or the third region 38 onto the first porous polymer 22 and solid sorbent material 24 may include laminating the second region 36 and/or the third region 38 to the first composite region 28. In various embodiments, the second region 36 and/or the third region 38 may be in the form of a polymer sheet. The concept of immobilizing by coating with the second region 36 and/or the third region 38 is described further below with respect to FIGS. 5A and 5B.

FIG. 4A is a perspective view of the first composite region 28 of the sorbent polymer composite article 20 prior to immobilization of block 108 (FIG. 3). The first composite region 28 comprises the first porous polymer 22 having the plurality of pores 32, the plurality of fibrils 34 and the plurality of nodes 30. In this state, the fibrils 34 are substantially straight. The plurality of pores 32 each comprise a pore size 60. The first porous polymer 22 of the first region 28 comprises the discrete area of the sorbent material 24 positioned within the pores 32. The solid particles of the sorbent material 24 and/or the carrier 26 may be loosely packed in the pores 32 but not yet immobilized.

FIG. 4B is a perspective view of the first composite region 28 of the sorbent polymer composite article 20 of FIG. 4A after the immobilizing step of block 108 described with reference to FIG. 3,. In this state, the fibrils 34 are bent and/or wavy. The plurality of pores 32 now each have a pore size 62 that is less than the pore size 60 referenced in FIG. 4A. This shrinking of the fibrils 34 and tightening of the pores 32 aids in immobilizing the solid particles of the sorbent material 24 and/or the carrier 26 that is now tightly packed within the pores 32 of the first porous polymer 22. In certain instances where the solid particles are intended to absorb or adsorb, the process may cause the particles to swell and shrink repeatedly. The bent or wavy fibrils have stored length and allow this cyclic change in size or thickness without failure (tensile breakage) for the fibrils.

Another variation of method 100 of FIG. 3 for forming the sorbent polymer composite article 20 will additionally be described with reference to FIGS. 5A and 5B.

FIG. 5A is a schematic view of a portion of the sorbent polymer composite article 20 during the combining step of block 106 (FIG. 3). The sorbent polymer composite article 20 is shown with the third region 38 positioned adjacent the lower, second side 74 of the first composite region 28, such that the lower, second side 74 is sealed and the upper, first side 72 is open. The sorbent material 24 may be provided in a dry particle form, entrained within a forced flow 27, and introduced through the open, first side 72 of the first porous polymer 22. The sorbent material 24 may become trapped against the sealed, second side 74 and between the nodes 30 and the fibrils 34 of the first porous polymer 22, thereby retaining the sorbent material 24 within the pores 32 of the first porous polymer 22.

FIG. 5B is a schematic view of the sorbent polymer composite article 20 during the immobilizing step of block 108 (FIG. 3). In addition to the third region 38 sealing the lower, second side 74 of the first composite region 28 as in FIG. 5A, the sorbent polymer composite 20 further comprises the second region 36 sealing the upper, first side 72 of the first composite region 28, thereby immobilizing the sorbent material 24 within the polymer 20 of the first composite region 28 between the second and third regions 36, 38.

### EXAMPLES

### Example 1

An expanded porous polymer sheet of ePTFE made in accordance with the teachings of U.S. Pat. No. 5,814,405 to Branca, et al, was first provided. Diamond dust particles of a size between 2-6 μm were mixed with a 70% IPA 30% H₂O solvent. Using a syringe, the mixture of diamond particles and IPA was pulled through the sheet of ePTFE. The mixture was then pushed back out through the polymer sheet. This process was repeated 10 times. In this case, the particles were infused or entrained into the ePTFE membrane and, during drying of the solvent, the fibrils shrank to hold/grip the particles so they do not become fugitive. Amount of shrinkage may be varied based on restraint of the membrane during the drying process.

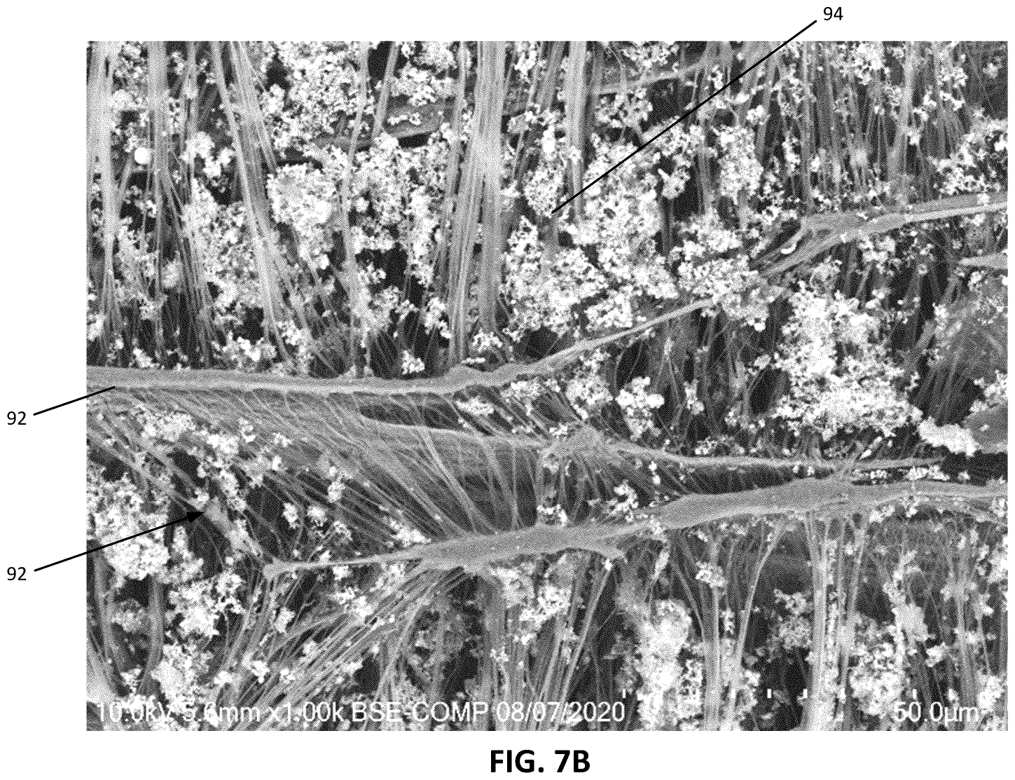

FIGS. 6A, 6B, and 6C are SEM images of the porous polymer with the diamond particles having a size of about 2 μm to 6 μm held in the pores of the polymer created in this Example. FIGS. 6A-6C are presented with notations indicting the magnification and scale of the respective SEM images. FIG. 6A is at a 100× magnification with a scale showing the length of 500 μm relative to the image (such that a distance between two consecutive vertical markers represents 50 μm). Indicated at the bottom of the image are: 10.0 kV 5.5 mm×100 BSE-COMP 08/07/2020. FIG. 6B is at a 1000× magnification with a scale showing the length of 50 μm relative to the image (such that a distance between two consecutive vertical markers represents 5 μm). Indicated at the bottom of the image are: 10.0 kV 5.5 mm×1.00 k BSE-COMP 08/07/2020. FIG. 6C is at a 1000× magnification with a scale showing the length of 50 μm relative to the image (such that a distance between two consecutive vertical markers represents 5 μm). Indicated at the bottom of the image are: 10.0 kV 4.8 mm×1.00 k BSE-COMP 08/07/2020. FIG. 6B and FIG. 6C are higher magnification SEMs taken of the same sample (of FIG. 6A) with the polymer sheet and diamond particles positioned within the pores of the sheet to create the first region. FIGS. 6A and 6B show surface SEM images of ePTFE filled and/or embedded with diamond particles. FIG. 6C is a cross-section of the diamond-filled polymer shown in FIGS. 6A-6B, with diamond particles observable throughout the thickness of the ePTFE film and with loose particles observable on one side of the film. It is illustrated in these images that the diamond particles 90 are positioned within the pores 93 between the fibrils 92 of the polymer. In FIG. 6C, many of the diamond particles 90 were pulled upward toward an upper surface of the polymer, with some diamond particles 90 being loosely present toward a lower surface of the polymer.

### Example 2

An expanded porous polymer sheet of ePTFE made in accordance with the teachings of U.S. Pat. No. 5,814,405 to Branca, et al, was first provided. Iron oxide particles having an average size of about 0.5 μm (with agglomerates of about 2-8 μm) were added to a liquid carrier (tap water) to form a slurry. The porous polymer membrane was wet with an IPA solvent. Similar to Example 1, the water and iron oxide particle slurry was pulled through the membrane and subsequently pushed back out. This process was repeated 10 times. In this example, the samples were dried and then subject to a temp of approx. 200 C. This elevated temperature causes a relaxation of residual stresses within the membrane. It should be noted that membranes with higher initial expansion properties may shrink more than other membranes with lower expansion properties.

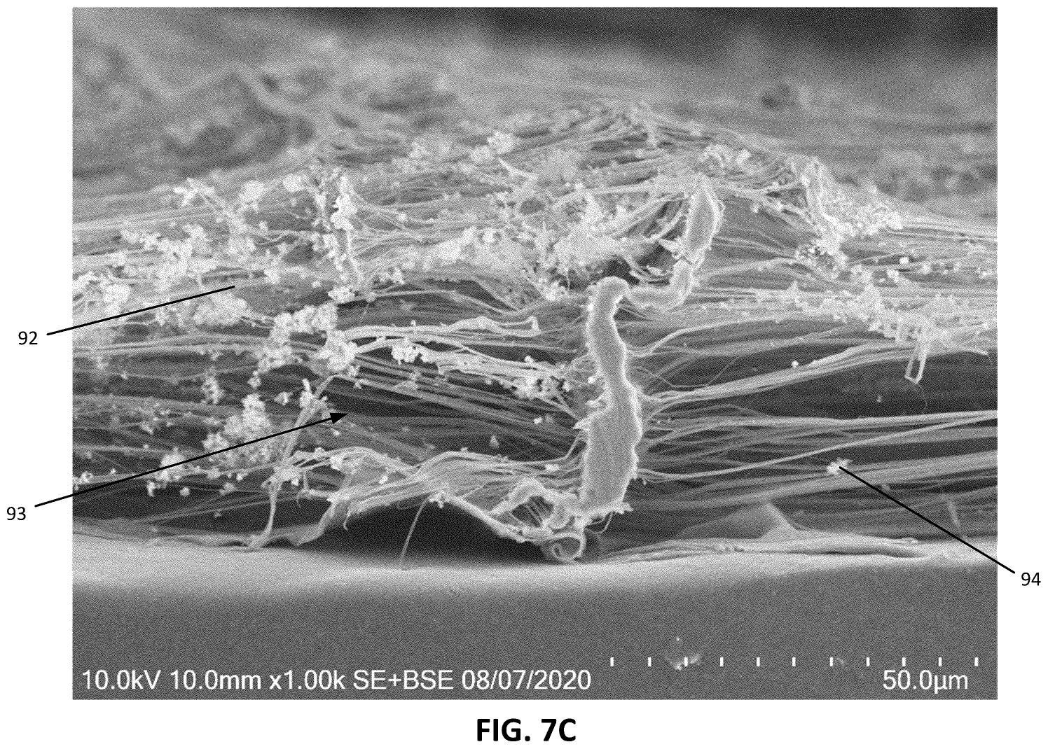

FIGS. 7A, 7B, and 7C are the SEM images taken of this sample of the porous polymer with iron oxide particles having a size of <0.5 μm with agglomerates of about 2 μm to 8 μm held in the pores of the polymer created in this Example. FIGS. 7A-7C are presented with notations indicting the magnification and scale of the respective SEM images. FIG. 7B and FIG. 7C are higher magnification SEMs taken of the same sample of this Example (and shown in FIG. 7A) with the iron oxide particles 94 positioned within the polymer. FIG. 7A is at a 100× magnification with a scale showing the length of 500 μm relative to the image (such that a distance between two consecutive vertical markers represents 50 μm). Indicated at the bottom of the image are: 10.0 kV 5.6 mm×100 BSE-COMP 08/07/2020. FIG. 7B is at a 1000× magnification with a scale showing the length of 50 μm relative to the image (such that a distance between two consecutive vertical markers represents 5 μm). Indicated at the bottom of the image are: 10.0 kV 5.6 mm×1.00 k BSE-COMP 08/07/2020. FIG. 7C is at a 1000× magnification with a scale showing the length of 50 μm relative to the image (such that a distance between two consecutive vertical markers represents 5 μm). Indicated at the bottom of the image are: 10.0 kV 10.0 mm×1.00 k SE+BSE 08/07/2020. FIGS. 7A and 7B are SEM images of the surface of the polymer sheet comprising the first region with the polymer and iron oxide particles 94. FIG. 7C is a cross-section of the iron-oxide-filled polymer shown in FIGS. 7A-7B, with embedded iron oxide particles observable throughout the thickness of the ePTFE film. It is illustrated in these images that the iron oxide particles 94 are positioned within the pores 93 between the fibrils 92 of the polymer. Compared to the larger particles 90 of Example 1 (FIG. 6C), the smaller particles 94 of this Example 2 (FIG. 7C) were susceptible to being pulled through completely the ePTFE sheet.

### Prophetic Example 3

Using laminates to aid the infusing process is envisioned. A membrane such as the Branca membrane in Examples 1 and 2 above may have an additional membrane laminated to one side. This membrane could be very thin and have a much smaller, or tighter microstructure than the Branca membrane. The particles will be applied from the Branca membrane side using positive pressure from that side or negative pressure from the other side, or both. The solid particles will penetrate into the microstructure and stop at the interface of the tighter porosity region. When the Branca membrane is “full” of particles, the infusion process can be ended and followed with a capping region or with the shrinking process or both. This process envisioned is described with reference to FIGS. 5A and 5B in the present disclosure and may be applied in use with this membrane.

1. A sorbent polymer composite article comprising:
a first region having a solid sorbent and a first porous polymer, the first porous polymer comprising a plurality of pores, the first region having at least a portion of the solid sorbent immobilized within at least some of the pores of the first porous polymer, and the first region being configured to receive carbon dioxide through the first porous polymer and adsorb the carbon dioxide onto the solid sorbent.

2. The sorbent polymer composite article of claim 1, wherein the solid sorbent is an ion exchange resin, zeolite, activated carbon, alumina, metal-organic frameworks, or polyethyleneimine (PEI).

3. The sorbent polymer composite article of claim 1, further comprising a second region having a second porous polymer and a third region having a third porous polymer, the second porous polymer of the second region and the third porous polymer third region being hydrophobic.

4. The sorbent polymer composite article of claim 3, wherein the first porous polymer, the second porous polymer, and the third porous polymer are the same.

5. The sorbent polymer composite article of claim 1, wherein the first region has a thickness that is less than 5.0 mm.

6. The sorbent polymer composite article of claim 1, wherein the first porous polymer of the first region is expanded polytetrafluoroethylene, polytetrafluoroethylene, or expanded polyethylene.

7. The sorbent polymer composite article of claim 1, wherein a tensile strength of the first porous polymer after the solid sorbent is immobilized within at least some of the pores of the first porous polymer remains approximately equal to an original tensile strength of the first porous polymer before the solid sorbent is immobilized within at least some of the pores of the first porous polymer

8. The sorbent polymer composite article of claim 3, wherein the second region is arranged on a first side of the first region and the third region is arranged on a second side of the first region.

9. The sorbent polymer composite article of claim 3, wherein the second and third porous polymer of the second region and the third region, respectively, are one of at least polytetrafluoroethylene, expanded polytetrafluoroethylene and expanded polyethylene.

10. A method of combining a solid sorbent and a first porous polymer
comprising the steps of:
providing a first porous polymer having a plurality of pores,
providing a solid sorbent,
combining the sorbent and the first porous polymer such that at least a portion of the sorbent is disposed within the pores of the first porous polymer; and
immobilizing the solid sorbent within the pores of the first porous polymer.

11. The method of claim 10, wherein the step of combining the sorbent and porous polymer includes delivering a slurry comprised of the sorbent to the first porous polymer, and wherein the slurry further comprises a carrier.

12. (canceled)

13. The method of claim 10, wherein the step of combining the sorbent and the first porous polymer comprises applying the sorbent in a dry particle form to the first porous polymer under a forced air flow.

14. The method of claim 10, wherein the step of immobilizing the solid
sorbent further
comprises the steps of:
applying a solvent to the combination of the first porous polymer and the sorbent; and
evaporating the solvent.

15. The method of claim 14, wherein the evaporating step shrinks a pore size of the plurality of pores of the first porous polymer.

16. The method of claim 10, wherein the immobilizing step comprises applying heat to the first porous polymer and the sorbent, and wherein applying the heat to the first porous polymer and the sorbent shrinks a pore size of the plurality of pores of the first porous polymer.

17. (canceled)

18. The method of claim 10, wherein the immobilizing step further includes attaching a second region to the first porous polymer having the sorbent material, and wherein the process of attaching includes laminating the second region to the first porous polymer having the sorbent material.

19. (canceled)

20. An entrained polymer composite article comprising:
a first porous polymer comprising a plurality of nodes, a plurality of fibrils that connect adjacent nodes, and a plurality of pores defined by the nodes and the fibrils, the first porous polymer having:
a first state in which the fibrils are substantially straight, and
a second state in which the fibrils are substantially wavy or bent and the pores are smaller in size than in the first state; and
a plurality of solid particles being retained in the pores in the first state and immobilized in the pores in the second state.

21. The entrained polymer composite article of claim 20, wherein the plurality of solid particles comprise:
a carrier; and
a sorbent material covering the carrier.

22. The entrained polymer composite article of claim 20, wherein the solid particles have an average particle size of about 0.1 μm to about 100 μm.

23. The entrained polymer composite article of claim 20, further comprising:
a second porous polymer region;
a third porous polymer region, wherein the first porous polymer is sandwiched between the second and third porous polymer regions; and
an end-sealing region that extends between the second and third porous polymer regions;
wherein the second porous polymer region, the third porous polymer region, and the end-sealing region cooperate to protect the solid particles in the first porous polymer.
